(19) United States
(12) Patent Application Publication
(10) Pub. No.: US 2025/0329482 A1
(43) Pub. Date: Oct. 23, 2025

(54) POWER RESISTOR DEVICE

(71) Applicant: Aston Resistors S.r.l., Pavia (PV) (IT)

(72) Inventor: Daniele Gianluigi FINARELLI, Milan (IT)

(21) Appl. No.: 18/866,931

(22) PCT Filed: May 19, 2023
(86) PCT No.: PCT/EP2023/063523

§ 371 Date: Nov. 18, 2024

(30) Foreign Application Priority Data
May 19, 2022 (GB) 2207375.3

(51) Int. Cl. H01C 1/02; H01C 17/02; H05B 3/24

(52) U.S. Cl. CPC H01C 1/02; H01C 17/02; H05B 3/24

(57) ABSTRACT

A power resistor device comprising: a power resistor assembly; and an enclosure, the enclosure comprising: a first planar portion; a second planar portion; a first flexible resilient portion; and a second flexible resilient portion; wherein the power resistor assembly is arranged between the first and second planar portions of the enclosure; wherein the first flexible resilient portion and the second flexible resilient portion each form a bend between the first and second planar portions; and wherein the first flexible resilient portion and the second flexible resilient portion each contact a planar portion at a respective contact point, each contact point being spaced from a respective edge of the power resistor assembly towards a centre of the respective planar portion.

### FIELD OF INVENTION

The present disclosure relates to a power resistor device comprising a power resistor assembly, an enclosure for a power assembly, and methods for enclosing a power resistor assembly.

### BACKGROUND

Devices that transform electrical power into thermal power, such as power resistors including braking resistors and heaters, are often packaged or encased in an enclosure in such a way as to introduce pressure to the device structure and the enclosure so that the layers of the power resistor assembly itself (e.g. resistor material and insulating material) are pressed tightly together, and that the enclosure is also pressed tightly together with the device.

It is important that the components of the power resistor assembly and the enclosure are forced together to create a good thermal and mechanical contact between the different materials and the external environment to enable thermal dissipation. However, achieving a good uniform contact across the whole area of the device is challenging, and in practice the enclosure often becomes deformed (e.g. due to the pressure applied at the edge and/or due to heating through use) away from areas where direct pressure is applied (usually at the edges of the enclosure) creating uneven pressure or even no pressure at all at those points.

Existing techniques to improve contact between the enclosure and the power resistor assembly include introducing additional joining points (such as welds, rivets, and/or screws) between sides of the enclosure, and/or adhering the enclosure to the outer layers (e.g. insulating layers) of the device (e.g. using thermally cured technical powder or technical concrete). However, additional joining points greatly increase the complexity of the device insulation, and provide little improvement to the contact between the enclosure and the power resistor assembly, and between layers of the power resistor assembly, at areas away from the joining points. In addition, the use of adhesive greatly increases the thickness and thermal resistance of the enclosure.

### SUMMARY

There is therefore a need for an enclosure for a power resistor assembly (e.g. an assembly comprising a power resistor and any insulation layers) that provides improved thermal and/or mechanical contact between the materials/layers of the power resistor assembly and/or between the power resistor assembly and the enclosure.

It will be understood that the term “power resistor assembly” as used herein refers to the components of a power resistor device that are enclosed within an enclosure. For example, the power resistor assembly may comprise a plurality of layers of material including a resistor and an insulating material. It will be further understood that the term “power resistor device” as used herein comprises an enclosed power resistor assembly.

In brief, the present disclosure provides a power resistor device, and an enclosure for a power resistor assembly, such that the power resistor assembly is enclosed by an enclosure comprising flexible resilient portions. The flexible resilient portions form a distributed spring that keeps the enclosure and the power resistor assembly, and/or any layers of the power resistor assembly, pressed firmly together to provide a good and well-distributed mechanical and thermal contact. When such an enclosure expands (e.g. due to heating and expansion of the power resistor assembly), the distributed spring arrangement is further able to accommodate the expansion of the different enclosed layers, which may each have different rates of expansion, due to the elastic effect of the flexible portions and thus maintain the good thermal contact distributed throughout the device and/or assembly.

According to an aspect of the present disclosure, there is provided a power resistor device comprising: a power resistor assembly; and an enclosure, the enclosure comprising: a first planar portion; a second planar portion; a first flexible resilient portion; and a second flexible resilient portion; wherein the power resistor assembly is arranged between the first and second planar portions of the enclosure; wherein the first flexible resilient portion and the second flexible resilient portion each form a bend between the first and second planar portions; and wherein the first flexible resilient portion and the second flexible resilient portion each contact a planar portion at a respective contact point, each contact point being spaced from a respective edge of the power resistor assembly towards a centre of the respective planar portion.

In some examples, the one or both of the flexible resilient portions is not/are not continuous with the respective planar portion. A contact point may comprise a point at which a flexible resilient member meets a face of the respective planar portion (e.g. a face of the planar portion opposite a face of the planar portion that faces the power resistor assembly).

In some examples, one or both of the flexible resilient portions is/are continuous with the respective planar portion (e.g. the flexible resilient portions and the planar portions may be formed from a single piece, such as a tube). A contact point may comprise a point at which a flexible resilient member is delineated from a respective planar portion. For example, the contact point may comprise a bend, fold, crimp, corrugation, or the like. The contact point may form a direct contact with the power resistor assembly.

Advantageously, in a power resistor device as described herein, the pressure applied between the first planar portion and the second planar portion is distributed (e.g. substantially uniformly) across the entire area of the power resistor assembly, thereby maintaining a good thermal and mechanical contact between any material layers of a power resistor assembly, as well as between the planar portions of the enclosure and the power resistor assembly, and reducing or removing the possibility of local deformations to the planar portions of the enclosure which would otherwise result in degraded contact or total loss of contact in some places. For example, the enclosure may act as a distributed spring.

For example, in contrast to known enclosures for power resistor assemblies, pressure may be applied along the body of the power resistor assembly and not merely at the edges.

In some examples, each contact point is spaced from the respective edge of the power resistor assembly towards the centre of the respective planar portion by at least a distance equal to a thickness of the power resistor assembly. In such an arrangement, the impact of the edge of the power resistor assembly acting as a pivot point is significantly reduced, and so bending of the planar portions (which causes a reduction in the pressure applied to the power resistor assembly) is reduced or prevented.

Advantageously, spacing each contact point from the respective edge of the power resistor assembly towards the centre of the respective planar portion by at least a distance equal to a thickness of the power resistor assembly may result in an increase in the pressure applied to the power resistor assembly by 20 times or more, relative to known power resistor devices.

In some examples, the first and second flexible resilient portions each comprise at least one fold. In some examples, the first and second flexible resilient portions may comprise a plurality of folds.

One or more folds applied to the flexible resilient portions may prevent, or counteract, any vertical displacement (e.g. due to spring back) of the flexible resilient portions, and/or of the enclosed power resistor assembly. In some examples, a “fold” may comprise one or more of a crimp, kink, stamp, corrugation, or the like.

In some examples, the first and second flexible resilient portions together exert a pressure on the power resistor assembly of at least 5 kg/cm². In some examples, the first and second flexible resilient portions together exert a pressure on the power resistor assembly of at least 10 kg/cm². In some examples, the first and second flexible resilient portions together exert a pressure on the power resistor assembly of at least 15 kg/cm². Preferably, the first and second flexible resilient portions together exert a pressure on the power resistor assembly of at least 20 kg/cm².

The high pressure exerted by the first and second flexible resilient portions compared to known power resistor devices advantageously maintains a good and well-distributed mechanical and thermal contact between the layers of the power resistor assembly, and/or between the power resistor assembly and the planar portions of the enclosure.

According to another aspect of the present disclosure, there is provided a method for enclosing a power resistor assembly, the method comprising: disposing a power resistor assembly between a first planar portion and a second planar portion of an enclosure; forming bends between the first and second planar portions to form a first flexible resilient portion and a second flexible resilient portion of the enclosure; and forming respective contact points between each of the first and second flexible resilient portions and a respective planar portion, each contact point being spaced from a respective edge of the power resistor assembly towards a centre of the respective planar portion.

Advantageously, when a power resistor assembly is enclosed by the method described herein, the pressure applied between the first planar portion and the second planar portion is distributed (e.g. substantially uniformly) across the entire area of the power resistor assembly, thereby maintaining a good thermal and mechanical contact between any material layers of a power resistor assembly, as well as between the planar portions of the enclosure and the power resistor assembly, and reducing or removing the possibility of local deformations to the planar portions of the enclosure which would otherwise result in degraded contact or total loss of contact in some places. For example, the enclosure may act as a distributed spring.

In some examples, the method comprises forming the contact points such that each contact point is spaced from the respective edge of the power resistor assembly towards the centre of the respective planar portion by at least a distance equal to a thickness of the power resistor assembly. In such an arrangement, the impact of the edge of the power resistor assembly acting as a pivot point is significantly reduced, and so bending of the planar portions (which causes a reduction in the pressure applied to the power resistor assembly) is reduced or prevented.

Advantageously, spacing each contact point from the respective edge of the power resistor assembly towards the centre of the respective planar portion by at least a distance equal to a thickness of the power resistor assembly may result in an increase in the pressure applied to the power resistor assembly by 20 times or more, relative to known power resistor devices.

In some examples, forming the bends comprises a first deformation step and a second deformation step. The first deformation step and the second deformation step may be performed sequentially: for example, the first deformation step may be performed before the second deformation step. It will be understood that the first and second deformation steps are not necessarily performed consecutively; one or more additional steps in the formation of the bends may be performed between the first deformation step and the second deformation step. In some examples, one or more additional steps may be performed before the first deformation step. In some examples, one or more additional steps may be performed after the second deformation step.

Forming the bends in two deformation steps advantageously counteracts any vertical displacement (e.g. due to spring back) of the flexible resilient portions that may occur during their formation and which would otherwise lead to a reduction in the pressure applied to the power resistor assembly.

In some examples, the first deformation step comprises forming a bend to form the first flexible resilient portion, and the second deformation step comprises forming a bend to form the second flexible resilient portion. That is, the first flexible resilient portion may be formed before the second flexible resilient portion, or vice versa.

In other examples, the first and second flexible resilient portions may be formed at substantially the same time.

In some examples, the first deformation step comprises forming substantially curved bends, and the second deformation step comprises applying a force to the bends to counteract a vertical displacement of one or both of the flexible resilient portions.

The force may be applied in a substantially vertical direction (e.g. downwards towards the power resistor assembly), in a substantially horizontal direction, or a combination of the two. The second deformation step may comprise imparting a fold to the first and second flexible resilient portions. A “fold” may comprise one or more of a crimp, kink, stamp, corrugation, or the like. Preferably, the first and second deformation steps are performed such that a symmetry exists between the first and second flexible resilient portions. However, the first and second flexible resilient portions need not necessarily be deformed at the same time during the method described herein.

In some examples described herein, an enclosure for a power resistor assembly comprises two plates, wherein one or both plates is folded around the other plate and holds the other plate in place. Importantly, the folded (lip) portions of the plate(s) contact the other (opposite) plate(s) at contact points that are spaced from the edges of the respective other plate and/or from the edges of the power resistor assembly. This effectively forms a distributed spring that keeps the plates, and any layers of the power resistor assembly, pressed firmly together to provide a good and well-distributed mechanical and thermal contact. That is, the folded lip portion may form spring “arms”. When such an enclosure expands (e.g. due to heating and expansion of the power resistor assembly), the distributed spring arrangement is further able to accommodate the expansion of the different enclosed layers, which may each have different rates of expansion, due to the elastic effect of the folded lip portions and thus maintain the good thermal contact distributed throughout the assembly.

In some examples described herein, the spring arms can be formed from one or more separate folded pieces (e.g. two folded pieces), each folded piece contacting both plates at contact points that are spaced from the edges of the plates and generally being configured to apply pressure to the plates at said contact points.

Described herein is an enclosure for a power resistor assembly, the enclosure comprising:
a first plate and a second plate, the first and second plates each comprising a body portion, the body portions being arranged parallel to one another;
wherein at least one of the first plate and the second plate further comprises a lip portion, and wherein at least the other of the first plate and the second plate further comprises an edge;
wherein the lip portion of the at least one of the first plate and the second plate is folded around the other of the first and second plates; and
wherein the lip portion of the at least one of the first plate and the second plate contacts the body portion of the other of the first and second plates at a contact point, wherein the contact point is spaced from the edge of the other of the first and second plates.

It will be understood that, in general, one or both plates may be folded around the other.

Preferably, the enclosure described herein comprises at least two lip portions in total (e.g. one of the first or second plates comprising two lip portions, or first and second plates each comprising one lip portion), each lip portion of one plate contacting the other plate at a contact point spaced from the edge of the other plate. However, in some examples, only one lip portion may contact the other plate at a contact point spaced from the edge of the other plate (e.g. one plate could be partly attached at the edge of the other plate) such that only one spring “arm” is formed.

As described herein, the plates each comprise a body portion. In general, in use, the body portions of the plates are arranged on opposite sides of a power resistor assembly. It will be understood that, in general, the body portions of the plates are the parts of the plates that are arranged, in use, on either side of a power resistor assembly.

It will be understood that the contact point(s) being spaced from the respective edges of the plate(s) may mean that there is a non-zero spacing between each contact point and the respective edge. The enclosure may comprise a gap between each contact point and respective edge. Preferably, the gap extends to the folded lip portion (e.g. the arc formed by the folded lip portion).

The enclosure may be configured such that, in use, the contact points are spaced from an assembly edge, where it will be understood that the assembly edge is an edge of the power resistor assembly. It will be further understood that the contact point being spaced from the assembly edge may mean that the contact point is laterally spaced from a region of the other of the first and second plates that is disposed over the assembly edge (e.g. “laterally” may be a direction perpendicular to the assembly edge).

An enclosure as described herein advantageously causes the pressure applied between the first plate and the second plate to be distributed (e.g. substantially uniformly) across the entire area of the power resistor assembly, thereby maintaining a good thermal and mechanical contact between any material layers of a power resistor assembly, as well as between the plates of the enclosure and the power resistor assembly, and reducing or removing the possibility of local deformations to the plates of the enclosure which would otherwise result in degraded contact or total loss of contact in some places. For example, the enclosure may act as a distributed spring.

For example, in contrast to known enclosures for power resistor assemblies, pressure may be applied along the body of the power resistor assembly and not merely at the edges.

It will be understood that, in general, the contact point(s) may be dry contacts. That is, there may be no welding or adhesive between the lip portion(s) and the body portion(s) of the contacted plates. Advantageously, the effect of the distributed spring may maintain sufficient pressure such that the plates are forced together while also accommodating any expansion of the power resistor assembly.

In some examples, the lip portion(s) may be attached to the body portion(s), e.g. by welding such as spot welding.

Furthermore, the improved and uniform thermal and mechanical contact between the plates of the enclosure and the power resistor assembly may remove any need for adhesives, or additional welds, screws, or rivets, to attach the enclosure to the power resistor assembly, thereby facilitating a simplified process for enclosing a power resistor assembly. In some examples, a suitable thermal interface material, such as a high temperature binder (e.g. potassium silicate), may be employed between the plates and a power resistor assembly and/or layers of the power resistor assembly further to reduce thermal resistance between contacting surfaces.

Additionally, an enclosure as described herein advantageously maintains the good thermal and mechanical contact between the plates and the power resistor assembly, even as the power resistor assembly (e.g. a resistor element of the power resistor assembly) heats and expands.

In some examples, the lip portions are folded in a substantially arced shape.

Substantially arced lip portions may advantageously form spring arms which may further direct pressure along the body of the power resistor assembly (i.e. rather than merely at the edges).

In some examples, the enclosure comprises a gap between each contact point and respective edge. Preferably, the gap extends to the folded lip portion (i.e. the arc formed by the folded lip portion).

A gap (e.g. when the enclosure is in a non-expanded state) may further advantageously provide space for the enclosure to expand into (e.g. when the power resistor assembly heats up during use), thereby further allowing the enclosure to maintain its form and function even when in an expanded state.

Furthermore, a gap may advantageously be suitable for insertion of a fixing device, such as a screw, in some implementations.

The enclosure may be configured such that a substantially uniform pressure is applied across an area of a power resistor assembly disposed between the first plate and the second plate. A substantially uniform pressure advantageously prevents areas of local deformation from forming across the area of the power resistor assembly, where degradation or complete loss of contact between the enclosure and the power resistor assembly may otherwise occur. The area of the power resistor assembly may be an area of one or both faces of the power resistor assembly that are in contact with the plate(s) of the enclosure.

It will be understood that each contact point may be positioned, in principle, at any point between the edge of the power resistor assembly and a centre of the contacted plate.

There may exist an optimal position for the contact points such that a desired (e.g. optimal) pressure uniformity across the power resistor assembly can be achieved. The optimal position for the contact points may depend on several parameters, such as a stiffness and/or thickness and/or width of the plate(s), and/or a compliancy of the materials (e.g. layers) of the power resistor assembly.

In some examples, each contact point may be positioned substantially at a midpoint between the respective edge of the contacted plate and a centre of said contacted plate, and/or between a respective assembly edge and the centre of the contacted plate. Such a positioning of the contact points may be optimal, for example, where the stiffness of the plates of the enclosure is substantially greater than a stiffness of an insulation layer, and/or a resistor layer, of the power resistor assembly.

In some examples, at least one of the first plate and the second plate comprises aluminized steel.

In a specific example, we describe herein an enclosure for a power resistor assembly, the enclosure comprising: a first plate comprising two opposite edges; and a second plate, the second plate comprising a body portion, the body portion being arranged parallel to the first plate; wherein the second plate further comprises at least two lip portions, each lip portion being folded around the first plate; and wherein each lip portion contacts the first plate at a contact point, wherein the contact point of each lip portion is spaced from the respective edge of the first plate.

In a further specific example, we describe herein an enclosure for a power resistor assembly, the enclosure comprising: a first plate and a second plate, the first and second plates each comprising a body portion, the body portions being arranged parallel to one another; wherein the first plate and the second plate each comprise a respective lip portion and edge; wherein the lip portion of the first plate is folded around the second plate; and wherein the lip portion of the second plate is folded around the first plate; wherein the lip portions of the first and second plates contact the body portions of the respective other of the first and second plates at contact points such that the contact points are spaced from the respective edges of the other of the first and second plates.

Also described herein is a power resistor device comprising:
a power resistor assembly;
a first plate and a second plate, the first and second plates each comprising a body portion, wherein the power resistor assembly is arranged between the body portions of the first and second plates;
wherein at least one of the first plate and the second plate further comprises a lip portion, and wherein at least the other of the first plate and the second plate further comprises an edge;
wherein the lip portion of the at least one of the first plate and the second plate is folded around the other of the first and second plates; and
wherein the lip portion of the at least one of the first plate and the second plate contacts the body portion of the other of the first and second plates at a contact point, wherein the contact point is spaced from the edge of the other of the first and second plates.

Alternatively, or in addition, to being spaced from the edge of the other of the first and second plates, the contact point may be spaced from an assembly edge, where it will be understood that the assembly edge is an edge of the power resistor assembly. It will be further understood that the contact point being spaced from the assembly edge may mean that the contact point is laterally spaced from a region of the other of the first and second plates that is disposed over the assembly edge (e.g. “laterally” may be a direction perpendicular to the assembly edge).

A power resistor device as described herein advantageously causes the pressure applied between the first plate and the second plate to be distributed (e.g. substantially uniformly) across the entire area of the power resistor assembly, thereby maintaining a good thermal and mechanical contact between any material layers of a power resistor assembly, as well as between the first and second plates and the power resistor assembly, and reducing or removing the possibility of local deformations to the plates enclosure which would otherwise result in degraded contact or total loss of contact in some places. For example, the first and second plates may act as a distributed spring.

For example, in contrast to known power resistor devices, pressure may be applied along the body of the power resistor assembly and not merely at the edges.

It will be understood that, in general, the contact point(s) may be dry contacts. That is, there may be no welding or adhesive between the lip portion(s) and the body portion(s) of the contacted plates. Advantageously, the effect of the distributed spring may maintain sufficient pressure such that the plates are forced together while also accommodating any expansion of the power resistor assembly.

Furthermore, the improved and uniform thermal and mechanical contact between the plates and the power resistor assembly removes any need for adhesives, or additional welds, screws, or rivets, to attach the plates to the power resistor assembly, thereby facilitating a simplified process for manufacturing a power resistor device. In some examples, a suitable thermal interface material, such as a high temperature binder (e.g. potassium silicate), may be employed between e.g. the plates and the power resistor assembly further to reduce thermal resistance between contacting surfaces.

Additionally, a power resistor device as described herein advantageously maintains the good thermal and mechanical contact between the plates and the power resistor assembly, even as the power resistor assembly (e.g. a resistor element of the power resistor assembly) heats and expands.

In some examples, the lip portions are folded in a substantially arced shape.

Substantially arced lip portions may advantageously form spring arms such that pressure is further applied along the body of the power resistor assembly (i.e. rather than merely at the edges).

In some examples, the power resistor device comprises a gap between each contact point and respective edge. Preferably, the gap extends to the folded lip portion (e.g. the arc formed by the folded lip portion).

A gap may advantageously provide space for the power resistor device (e.g. the first and second plates) to expand into (e.g. when the power resistor assembly heats up during use), thereby further allowing the power resistor device to maintain its form and function even when in an expanded state.

Furthermore, a gap may advantageously be suitable for insertion of a fixing device, such as a screw, in some implementations.

The power resistor assembly, the first plate, and the second plate may be configured such that a substantially uniform pressure is applied across an area of a power resistor assembly disposed between the first plate and the second plate. A substantially uniform pressure advantageously prevents areas of local deformation from forming across the area of the power resistor assembly, where degradation or complete loss of contact between the first and second plates and the power resistor assembly may otherwise occur. The area of the power resistor assembly may be an area of one or both faces of the power resistor assembly that are in contact with the plate(s).

It will be understood that each contact point may be positioned, in principle, at any point between the edge of the respective contacted plate and a centre of said contacted plate.

There may exist an optimal position for the contact points such that a desired (e.g. optimal) pressure uniformity across the power resistor assembly can be achieved. The optimal position for the contact points may depend on several parameters, such as a stiffness and/or thickness and/or width of the plate(s), and/or a compliancy of the materials (e.g. layers) of the power resistor assembly.

In some examples, each contact point may be positioned substantially at a midpoint between the respective edge of the contacted plate and a centre of said contacted plate, and/or between a respective assembly edge and the centre of the contacted plate. Such a positioning of the contact points may be optimal, for example, where the stiffness of the plates is substantially greater than a stiffness of an insulation layer, and/or a resistor layer, of the power resistor assembly.

In some examples, at least one of the first plate and the second plate comprises aluminized steel.

Further described herein is a method for enclosing a power resistor assembly, the method comprising:
disposing a first plate on a first side of the power resistor assembly and a second plate on a second side of the power resistor assembly, the first plate and the second plate each comprising a body portion, such that the power resistor assembly is arranged between the body portions of the first and second plates;
wherein at least one of the first plate and the second plate further comprises a lip portion, and wherein at least the other of the first plate and the second plate further comprises an edge; and folding the lip portion of the at least one of the first plate and the second plate around the other of the first and second plates such that the lip portion contacts the body portion of the other of the first and second plates at a contact point, wherein the contact point is spaced from the edge of the other of the first and second plates.

Alternatively, or in addition, to being spaced from the edge of the other of the first and second plates, the contact point may be spaced from an assembly edge, where it will be understood that the assembly edge is an edge of the power resistor assembly. It will be further understood that the contact point being spaced from the assembly edge may mean that the contact point is laterally spaced from a region of the other of the first and second plates that is disposed over the assembly edge (e.g. “laterally” may be a direction perpendicular to the assembly edge).

A method for enclosing a power resistor assembly as described herein advantageously causes the pressure applied between the first plate and the second plate to be distributed (e.g. substantially uniformly) across the entire area of the power resistor assembly, thereby maintaining a good thermal and mechanical contact between any material layers of a power resistor assembly, as well as between the plates and the power resistor assembly, and reducing or removing the possibility of local deformations to the plates which would otherwise result in degraded contact or total loss of contact in some places. For example, the plates may act as a distributed spring.

For example, in contrast to known methods for enclosing power resistor assemblies, pressure may be applied along the body of the power resistor assembly and not merely at the edges.

Furthermore, the improved and uniform thermal and mechanical contact between the plates and the power resistor assembly removes any need for adhesives, or additional welds, screws, or rivets, to attach the plates to the power resistor assembly, thereby facilitating a simplified process for enclosing a power resistor assembly.

Additionally, a power resistor assembly that has been enclosed according to the methods described herein advantageously maintains the good thermal and mechanical contact between the plates and the power resistor assembly, even as the power resistor assembly (e.g. a resistor element of the power resistor assembly) heats and expands.

According to the method described herein, the power resistor assembly, the first plate, and the second plate may be arranged such that a substantially uniform pressure is applied across an area of a power resistor assembly disposed between the first plate and the second plate. A substantially uniform pressure advantageously prevents areas of local deformation from forming across the area of the power resistor assembly, where degradation or complete loss of contact between the first and second plates and the power resistor assembly may otherwise occur. The area of the power resistor assembly may be an area of one or both faces of the power resistor assembly that are in contact with the plate(s).

It will be understood that each contact point may be positioned, in principle, at any point between the edge of the respective contacted plate and a centre of said contacted plate.

There may exist an optimal position for the contact points such that a desired (e.g. optimal) pressure uniformity across the power resistor assembly can be achieved. The optimal position for the contact points may depend on several parameters, such as a stiffness and/or thickness and/or width of the plate(s), and/or a compliancy of the materials (e.g. layers) of the power resistor assembly to be enclosed.

In some examples, each contact point may be positioned substantially at a midpoint between the respective edge of the contacted plate and a centre of said contacted plate, and/or between a respective assembly edge and the centre of the contacted plate. Such a positioning of the contact points may be optimal, for example, where the stiffness of the plates is substantially greater than a stiffness of an insulation layer, and/or a resistor layer, of the power resistor assembly to be enclosed.

In some examples, folding the lip portion of the at least one of the first plate and the second plate around the other of the first and second plates may comprise forming a gap between each contact point and respective edge.

In a further example, it can be advantageous to introduce a slight fold or bend into the first and/or second plates towards the power resistor assembly. This may accommodate some of the above-described deformation of the plates, and may further increase pressure uniformity.

Additionally described herein is enclosure for a power resistor assembly, the enclosure comprising:
a first plate and a second plate, the first and second plates being arranged parallel to one another, the first and second plates each comprising an edge;
one or more folded pieces, each folded piece being folded around the first and second plates;
wherein each folded piece contacts each plate at a contact point, wherein the contact point is spaced from the edge of the respective plate.

Also described herein is a power resistor device comprising the power resistor assembly described above, and further describing a power resistor assembly, the power resistor assembly comprising an assembly edge. The power resistor assembly may be arranged between the first and second plates of the enclosure. Each contact point may be additionally spaced from the assembly edge.

The folded pieces may act as spring arms, such that the enclosure behaves as a distributed spring that keeps the plates, and/or any layers of the power resistor assembly, pressed firmly together to provide a good and well-distributed mechanical and thermal contact. The folded pieces may further act as vices that hold the first and second plates, and the power resistor assembly (when the enclosure is in use as part of a power resistor device) together.

For example, the folded pieces may be substantially C-shaped.

The enclosure may comprise at least two folded pieces, e.g. folded around opposite edges of the plates.

### BRIEF DESCRIPTION OF THE DRAWINGS

Some embodiments will now be described by way of example only with reference to the accompanying figures, in which:

FIG. 1 schematically illustrates an example of a known power resistor device;

FIG. 2 schematically illustrates a cross-section view of an example enclosure for a power resistor assembly as described herein;

FIG. 3 schematically illustrates a perspective view of an example enclosure for a power resistor assembly as described herein;

FIG. 4 schematically illustrates a cross-section view of another example enclosure for a power resistor assembly as described herein;

FIG. 5 illustrates a flow diagram of an example method for enclosing a power resistor assembly as described herein;

FIG. 6 schematically illustrates a cross-section view of a further example enclosure for a power resistor assembly as described herein;

FIGS. 7A and FIG. 7B schematically illustrate a cross-section view of a further example enclosure for a power resistor assembly as described herein;

FIGS. 8A and 8B schematically illustrate a cross-section view of a further example enclosure for a power resistor assembly as described herein;

FIGS. 9A and 9B schematically illustrate a cross-section view of a further example enclosure for a power resistor assembly as described herein;

FIGS. 10A and 10B schematically illustrate a cross-section view of a further example enclosure for a power resistor assembly as described herein;

FIGS. 11A and 11B schematically illustrate a cross-section view of a further example enclosure for a power resistor assembly as described herein;

FIGS. 12A and 12B schematically illustrate a cross-section view of a further example enclosure for a power resistor assembly as described herein;

FIGS. 13A, 13B, and 13C schematically illustrate a cross-section view of a further example enclosure for a power resistor assembly as described herein;

FIGS. 14A, 14B, and 14C schematically illustrate a cross-section view of a further example enclosure for a power resistor assembly as described herein; and

FIG. 15 illustrates a flow diagram of another example method of enclosing a power resistor assembly as described herein.

### DETAILED DESCRIPTION

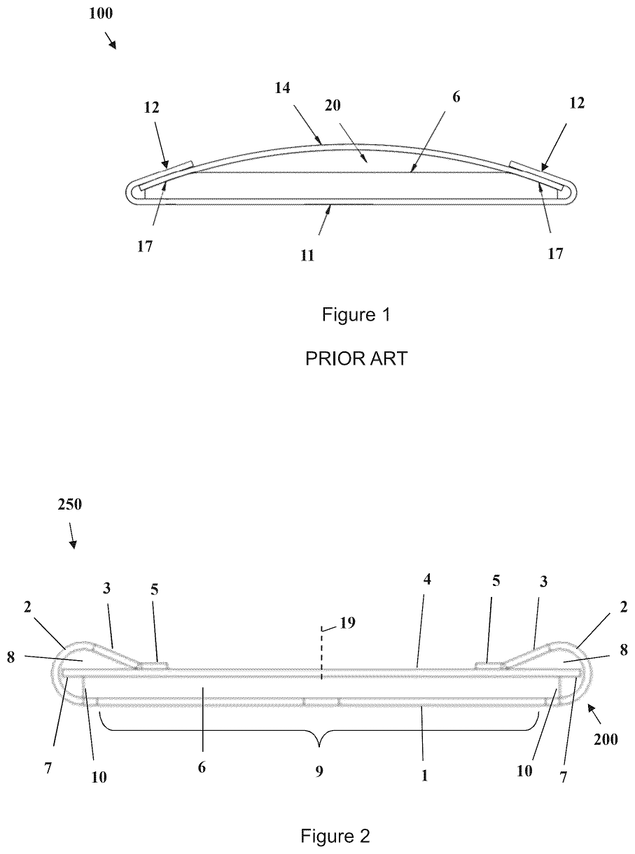

FIG. 1 schematically illustrates an example of a known power resistor device 100 (i.e. an enclosed power resistor assembly), such as a braking resistor or heater.

FIG. 1 shows a known power resistor device 100 comprising a power resistor assembly 6 that is enclosed by an enclosure, the enclosure comprising a first plate 14 and a second plate 11, wherein the second plate 11 is folded or otherwise deformed around portions 17 of the first plate 14 such that there are portions 12 of the second plate 11 that overlap the first plate 14 and that are attached at the edges of the first plate 14. The first 14 and second 11 plates are intended to introduce pressure to the power resistor device 100 such that the first 14 and second 11 plates are pressed together with the power resistor assembly 6. In some examples, the power resistor assembly 6 may comprise multiple layers of different materials, for example resistor layer(s), and insulating layer(s), and the first 14 and second 11 plates may further be intended to hold these multiple layers of the power resistor assembly 6 together as well.

However, known power resistor devices 100 of the kind illustrated in FIG. 1 can suffer from limited and/or uneven pressure between the power resistor assembly 6 and the plates 14, 11, for example due to deformation of the first plate 14. As further illustrated in FIG. 1, the pressure applied at the edges of the first plate 14 (by the portions 12 of the first second 11 that overlap, and are attached to, said edges) may cause the first plate 14 (which may be e.g. a flat metal sheet) to become bent at said edges. This bending may produce very strong pressure at the edges of the power resistor device 100, while leaving a central portion of the first plate 14 (e.g. between the edges) suspended from the power resistor assembly 6 (e.g. causing a bowing of the first plate 14). Such deformation of the first plate 14 may cause a void 20 (e.g. an air space) to form between the power resistor assembly 6 and the first plate 14, which can be highly detrimental to thermal dissipation of the power resistor device 100.

Known attempts to prevent the deformation of the first plate 14, and thereby to prevent the formation of voids 20, include introducing additional joining points (such as welds, rivets, and/or screws) between the first plate 14 and the portion of the second plate 11 on the opposite side of the power resistor assembly 6, and/or applying an adhesive between the power resistor assembly 6 and the first plate 14. However, additional joining points generally merely cause deformation of the first plate 14 to occur around the joining points, leading to the formation of voids at areas away from the joining points, while the inclusion of an adhesive between the power resistor assembly 6 and the plates 11, 14 tends to suffer from having a very different thermal expansion coefficient and poor adhesion, hence delamination occurs after very few power applications leading quickly to the complete detachment of power resistor assembly 6 from the plates 11, 14 and to the formation of voids which greatly increases the thermal resistance of the contact between the power resistor assembly 6 and the enclosure.

It is therefore an object of the present disclosure to enable improved (e.g. more uniform) thermal and/or mechanical contact between a power resistor assembly and an enclosure for the power resistor assembly. For example, an enclosure or power resistor device as described herein may exhibit reduced or eliminated tendency to form voids between the power resistor assembly and the enclosure in comparison to the prior art.

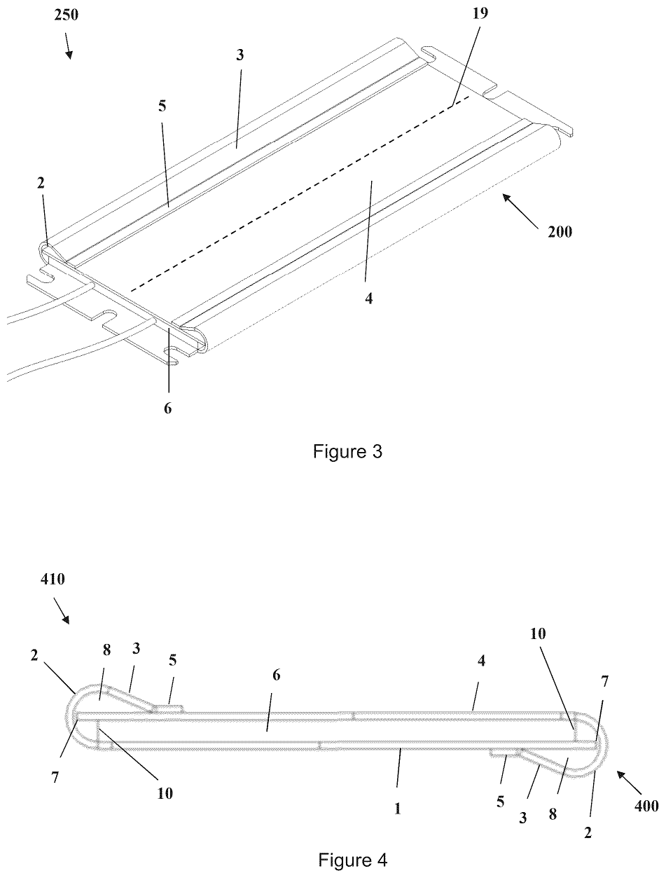

FIG. 2 illustrates a cross-section view of an example of an enclosure 200 for a power resistor assembly as described herein. FIG. 3 illustrates the enclosure 200 of FIG. 2 in a perspective view.

In the example illustrated in FIGS. 2 and 3, the enclosure 200 is shown enclosing a power resistor assembly 6. It will be understood that the term “power resistor device” as used herein refers to a device comprising an enclosed power resistor assembly. Therefore, FIGS. 2 and 3 also illustrate cross-section and perspective views, respectively, of an example of a power resistor device 250 as described herein.

The enclosure 200 comprises a first plate 4 and a second plate 1. The first plate 4 comprises two opposite edges 7, and the second plate comprises a body portion 9 and at least two lip portions 2. The first plate 4 and the second plate 1 are arranged parallel to one another. In the case of a power resistor device 250, the first 4 and second 1 plates enclose a power resistor assembly 6, the power resistor assembly 6 comprising two opposite edges 10 (also referred to herein as assembly edges 10). The at least two lip portions 2 of the second plate 1 are folded around the first plate 4, for example folded around the edges 7 of the first plate 4 or around edges 10 of the resistor assembly 6, whichever is wider, and contact to the first plate 4 at a contact point 5, for example on a side of the first plate 4 that is an opposite side to a side of the first plate 4 facing the second plate 1. In some examples, one or more of the lip portions 2 may be folded multiple times between the body portion 9 and the respective contact point 5. The contact points 5 are spaced from the edges 7 of the first plate 4 or the edges 10 of the resistor assembly 6 around which the respective lip portions 2 are folded. For example, a distance between a contact point 5 and the respective edge 10, 7 is non-zero, i.e. there is no contact or attachment between the lip portions 2 and the first plate 4 at the respective edges 7 or and/or assembly edges 10. For example, there may be a gap 8 between the arc, formed by the folded lip 2, and each contact point 5 and respective edge 7, 10.

By spacing the contact points 5 from the edges 7 of the first plate 4 or edges 10 of the resistor assembly 6, pressure is applied along the body of the resistor assembly 6 rather than at the edges of the resistor assembly 6. For example, the pressure applied between the plates 4, 1 of the enclosure 200 may be distributed (e.g. substantially uniformly) across the entire area of the power resistor assembly. In some examples, the plates 4, 1 of the enclosure 200 may act as a distributed spring.

The enclosure 200 described herein therefore achieves improved thermal and mechanical contact between e.g. the components of a power resistor device 250 (i.e. between the plates 4, 1 of the enclosure 200 and the power resistor assembly 6) in comparison to known power resistor devices. For example, the enclosure 200 described herein may reduce or eliminate the formation of voids or air spaces e.g. between the plate(s) 4, 1 and the power resistor assembly 6.

In some examples, the power resistor assembly 6 may comprise a plurality of layers (e.g. layers of different materials), such as one or more resistor layers and one or more insulator layers. An example of a suitable insulator layer material is mica. An example of a suitable resistor is a NiCr wire wound around a core layer. In some examples, the enclosure 200 as described herein may achieve improved contact between the layers of the power resistor assembly 6. For example, the resistor material may be pressed forcibly against or even partially into the insulating material, thus ensuring as firm as possible a thermal and mechanical contact and even reducing the distance across the insulating material while not compromising the insulation itself.

In some examples, at least some of the contacts between the plates 4, 1 and the power resistor assembly 6, and/or between layers of the power resistor assembly 6, may be dry contacts. In some examples, at least some of the contacts may be formed through the use of a suitable thermal interface material such as a high temperature binder (e.g. potassium silicate).

The lip portions 2 may form spring arms 3, e.g. of the distributed spring. For example, the lip portions 2 may be further configured or optimized further to direct pressure along the body of the power resistor assembly 6. For example, the lip portions 2 may be folded in a substantially arced shape.

In some examples, the lip portions 2 may comprise a fold or multiple folds, such that the lip portions 2 are configured as spring arms 3.

During operation of the power resistor device 250 (e.g. during operation of the power resistor assembly 6), the power resistor assembly 6 and/or the enclosure 200 may expand, e.g. due to heating. The enclosure 200 described herein may further advantageously maintain the good thermal and/or mechanical contact(s) between the plates 4, 1 and the power resistor assembly 6 (and/or between layers of the power resistor assembly 6) even during expansion. For example, the enclosure 200 can accommodate the different expansion rates of the components of the power resistor assembly 6. In some examples, if a gap 8 is present, the gap 8 may facilitate at least some expansion of the enclosure 200 without causing deformation or detachment of the first 4 and/or second 1 plate(s) from the power resistor assembly 6.

In some examples, a power resistor device 250 as described herein may exhibit improved mechanical and thermal contacts between the plates 4, 1 and the power resistor assembly 6 such that the power resistor device 250 may be capable of reaching temperatures of up to approximately 670° C. without deterioration of thermal/mechanical contact(s) between the plates 4, 1 and the power resistor assembly 6.

The contact points 5 may in principle be positioned at any point away from the respective edges 10 of the resistor assembly 6, up to a centre of the first plate 4 (represented in FIGS. 2 and 3 by the dashed line 19), i.e. a centre 19 of the width of the first plate 4. In general, the optimal positions for the contact points 5 depends on e.g. the compliancy of any power resistor assembly 6 layers, and/or the material stiffness and/or thickness of the plates 4, 1. In the case of stiff plates 4, 1 compared to the power resistor assembly, a rough approximation of the optimal positions for each of the contact points 5 is a midpoint between the centre 19 of the first plate and the respective assembly edges 10, i.e. either side of the centre 19 to provide a balanced and even pressure distribution. For example, each contact point 5 may be positioned substantially at a midpoint between the respective edge 10 of the resistor assembly 6 and a centre 19 of the first plate 4.

The first 4 and/or second 1 plates may comprise any suitable material having any suitable stiffness, for example aluminium, steel, and/or aluminized steel of suitable thickness to achieve the suitable stiffness.

FIG. 4 illustrates a cross-section view of another example of an enclosure 400 for a power resistor assembly. Similarly to FIGS. 2 and 3 described hereinabove, FIG. 4 also illustrates a cross-section view of a power resistor device 410.

In principle, the enclosure 400 illustrated in FIG. 4 behaves similarly to the enclosure 200 illustrated in FIGS. 2 and 3 and described hereinabove. That is, the enclosure 400 illustrated in FIG. 4 comprises first 4 and second 1 plates arranged parallel to one another and on opposite sides of a power resistor assembly 6. The plates 4, 1 and the power resistor assembly 6 are forced together by lip portions 2 that form spring arms 3. However, in contrast to the enclosure 200 illustrated in FIGS. 2 and 3, the first 4 and second 1 plates of the enclosure 400 illustrated in FIG. 4 each comprises a lip portion 2 and an edge 7. The lip portions 2 of each plate 4, 1 are each folded around the other (opposite) plate 1, 4 and contact the (body portion of the) other plate 1, 4 at a contact point 5 that is spaced from the respective edge of the other plate 1, 4 and/or from the edge 10 of the resistor assembly 6.

As illustrated in FIG. 4, a gap 8 may be present between the arc, formed by the folded lip 2, and each contact point 5 and respective edge 7 and/or respective assembly edge 10.

In a further example (not illustrated), one of the first and second plates could comprise one lip portion that is folded around the other of the first and second plates, and that contacts the (body portion of the) other plate at a contact point spaced from the edge of the other plate. One of the first and second plates could additionally contact to, or be attached to, the other of the first and second plates at the edge of the other plate. In other words, in the further example, an enclosure may comprise only one folded lip portion that can function as a spring arm. Preferably, however, the enclosure comprises at least two spring arms.

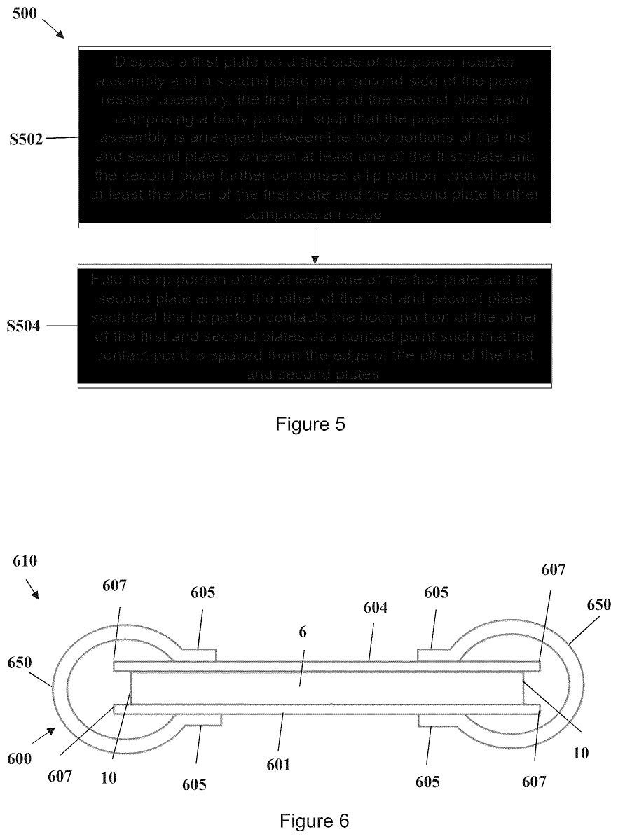

FIG. 5 illustrates a flow diagram of an example method 500 for enclosing a power resistor assembly as described herein.

At step S502 of the method 500, a first plate 4 is disposed on a first side of a power resistor assembly 6 and a second plate 1 is disposed on a second side of the power resistor assembly 6. The first plate 4 and the second plate 1 each comprise a body portion 9, such that the power resistor assembly 6 is arranged between the body portions 9 of the first 4 and second 1 plates. At least one of the first plate 4 and the second plate 1 further comprises a lip portion 2, and at least the other of the first plate 4 and the second plate 1 further comprises an edge 7.

At step S504 of the method 500, the lip portion 2 of the at least one of the first plate 4 and the second plate 1 is folded around the other of the first 4 and second 1 plates such that the lip portion 2 contacts the body portion 9 of the other of the first 4 and second 1 plates at a contact point 5 such that the contact point 5 is spaced from the edge 7 of the other of the first 4 and second 1 plates and/or from edge 10 of the resistor assembly 6.

In some examples, the method described herein may provide an enclosed power resistor assembly (i.e. a power resistor device) that is substantially the same as the power resistor device 250 illustrated in FIGS. 2 and 3 and described herein, and/or the power resistor device 410 illustrated in FIG. 4 and described herein.

FIG. 6 illustrates a further example of an enclosure 600 for a power resistor assembly 6 (where it will be understood that the enclosed power resistor assembly 6 and the enclosure 600 together form a power resistor device 610). First 604 and second 601 plates of the power resistor assembly 600 are arranged parallel to one another (on either side of the power resistor assembly), and one or more folded pieces 650 is folded around edges 607 of the plates 604, 601. In the example illustrated in FIG. 6, two C-shaped folded pieces 650 are employed. The folded pieces 650 act as spring arms and contact the plates 604, 601 at contact points 605 spaced from the edges 607 of the plates and/or the edges 10 of the power resistor assembly, thus forming a distributed spring in a manner similar to that discussed above in relation to the examples illustrated in FIGS. 2-4. The folded pieces 650 also act as vices, which clamp the plates 604, 601 and the power resistor assembly 6 together. One or more of the contact points 605 may be attached to the respective plate 604, 601 (e.g. by welding such as spot welding), but this is not necessarily the case.

To demonstrate the improved performance of the power resistor device (i.e. an enclosed power resistor assembly) according to the present disclosure, the inventors conducted a power test on two power resistor devices (Resistor A and Resistor B, respectively). Resistor A corresponds to the power resistor device 250 illustrated in FIGS. 2 and 3 and described hereinabove, while Resistor B corresponds generally to a known power resistor device of the kind illustrated in FIG. 1. Each of Resistor A and Resistor B comprises a flat resistor, and each of the flat resistors has the same geometric dimensions, in particular length, width and thickness, as well as the same insulating material and thickness, as well as the same internal resistor structure. Thermocouples were fixed on the same position for both Resistor A and Resistor B, externally at the centre of the enclosure and internally embedded in the resistor winding structure, close to the middle of the resistor. The same electric power is dissipated by the resistor wire. The results of the comparison are summarised in Table 1, and discussed below.

TABLE 1
Results of comparative power test
between Resistor A and Resistor B.

| | Resistor A | Resistor B |
|---|---|---|
| Applied Power (W) | 85.66 | 85.43 |
| Approx. resistor wire T (° C.) | 590 | 932 |
| Approx external T(° C.) | 200 | 200 |
| Rthc-a (K/W) | 2.33 | 2.33 |
| Rthw-c (K/W) | 4.55 | 8.58 |

The external temperature is extremely similar as the external geometry is very similar. The thermal resistance (case to ambient) Rthc-a is calculated as 2.3° C./W. The resistor wire temperature however, shows a large difference between Resistor A and Resistor B. The thermal resistance (wire to case) for Resistor A Rthw-c is calculated as 4.6° C./W. while the thermal resistance (wire to case) for Resistor B Rthw-c is calculated 8.6° C./W (see Table 1). The Rthw-c of Resistor A is nearly half that of Resistor B and the inventors account for this difference due to the poor surface contact between the layers of Resistor B because they are not being pressed together as they are in Resistor A.

Further examples of power resistor devices and enclosures according to the present disclosure will now be described.

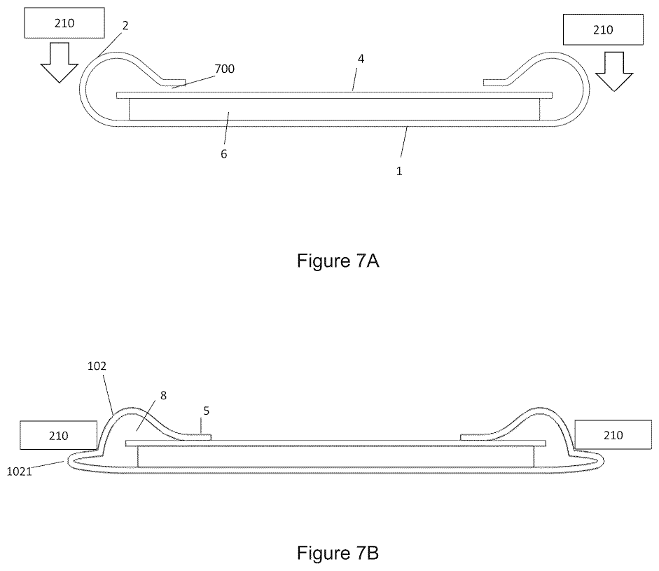

FIGS. 7A and 7B illustrate an example of a power resistor device in which a power resistor assembly is enclosed by a first planar portion and a second planar portion, the first planar portion comprising a first plate 4 and the second planar portion comprising a second plate 1.

As shown in FIG. 7A, first and second flexible resilient portions are formed as lip portions 2 of the second plate 1. The lip portions 2 may be formed by bends. However, following the bend to form the lip portions 2, the lip portions 2 may spring back upwards, leading to a vertical displacement 700 where the lip portions 2 should contact the first plate 4. The formation of the flexible resilient portions (lip portions 2) may be referred to as a first deformation step (e.g., in the example of FIG. 7A, the second plate 1 is deformed to form the lip portions 2).

One or more additional folds or bends may therefore be introduced into the flexible resilient portions, e.g. by using a tool 210 to counteract the vertical displacement 700. The tool 210 may comprise, e.g., a press, a stamp press, a mould press, or the like. FIG. 7B illustrates the power resistor device of FIG. 7A immediately after a force is provided by the tool 210 at the edges of the lip portions 2 (which force may introduce a crimp or kink to the lip portions in some examples). The providing of the force by the tool 210 may be referred to as a second deformation step. The resulting power resistor assembly in FIG. 7B comprises two flexible resilient portions (lip portions 2), each comprising two “folds” 102, 1021. The lip portions 2 each contact the first plate 4 at a contact point 5. The contact points 5 are spaced from the edge of the power resistor assembly 6 towards the centre of the first plate (i.e. the centre of the first planar portion, such as the centre 19 illustrated in FIG. 3, or away from the edges of the power resistor assembly 6). The flexible resilient portions each define a gap 8 as described above.

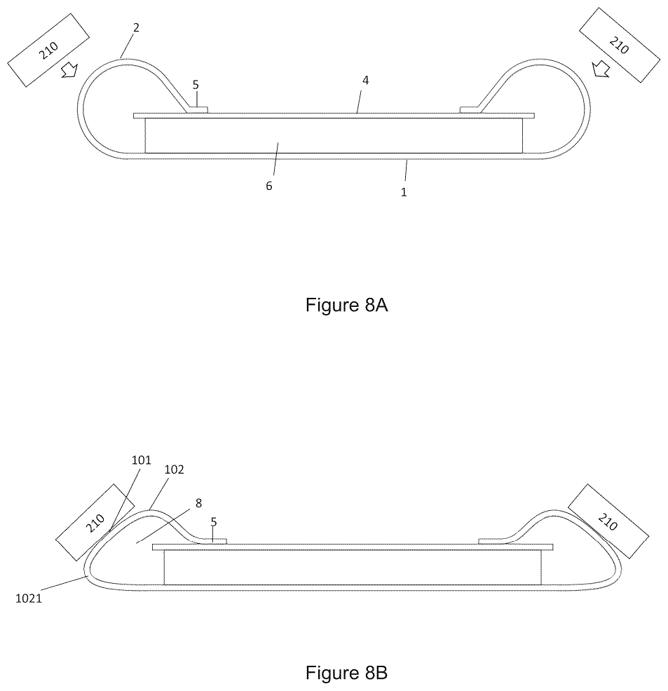

In some examples, a force having horizontal and vertical components may be applied to introduce folds to the flexible resilient portions in the second deformation step. FIG. 8A illustrates a power resistor assembly substantially similar to the power resistor assemblies illustrated in FIGS. 2 and 7A and described above. To prevent or counteract any vertical displacement of the flexible resilient portions (lip portions 2) at the contact points 5, a tool 210 may be used to apply a force to the flexible resilient portions such that the flexible resilient portions each comprise two folds 102, 1021. In the example of FIGS. 8A and 8B, the tool 210 is angled such that the force has a horizontal component and a vertical component, leading to part 101 of the flexible resilient portions being flattened against the tool 210.

While FIGS. 8A and 8B illustrate the formation of the folds 102, 1021 in a single step, it will be appreciated that the folds 102, 1021, and the flattened parts 101, could be introduced in multiple deformation steps (e.g. by providing first a horizontal force, and then a vertical force, or vice versa).

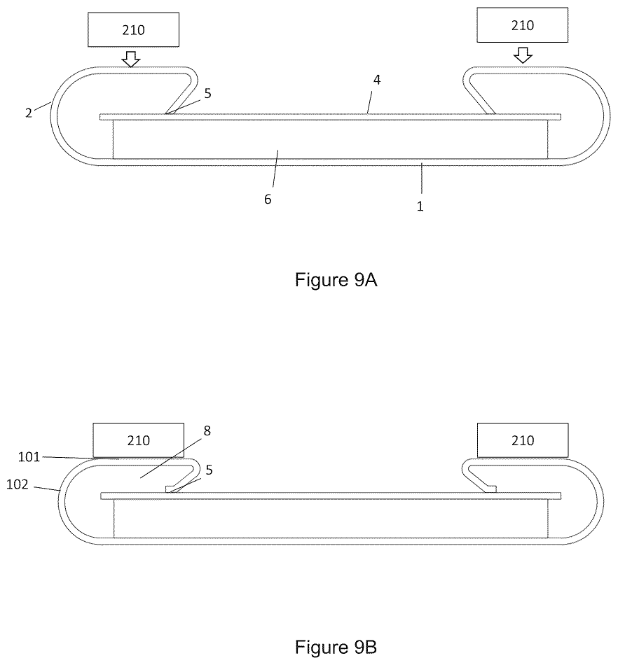

FIGS. 9A and 9B illustrate a further example of a power resistor assembly according to the present disclosure in which the flexible resilient members (first and second lip portions 2) are folded back on themselves before contacting the first planar portion (first plate 4) at the contact points 5. The formation of the flexible resilient members in this way may constitute a first deformation step. In a second deformation step, a force (e.g. a vertical force) may be applied by a tool 210 to counteract any vertical displacement at the contact points 5, as described above. The flexible resilient portions following the second deformation step may comprise a bent, curved, or folded part 102, and a flattened part 101.

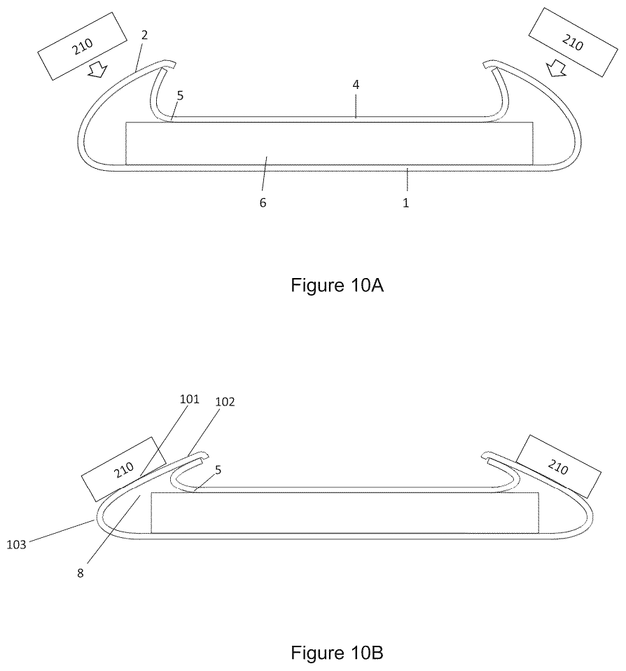

FIGS. 10A and 10B illustrate another example of a power resistor according to the present disclosure, in which the first plate 4 is folded upwards at its edges, and meets the lip portions 2 of the second plate 1. In this example, the flexible resilient portions can be said to comprise the folded parts of the first plate 4 and the lip portions 2. The first deformation step may comprise the folding, or bending, of the first plate 4 and the second plate 1 to form the folded parts of the first plate 4 and the lip portions 2. The contact points 5 are formed at the bends in the first plate 4. In the second deformation step, a tool 210 is employed as described above to counteract any vertical displacement. The second deformation step may introduce a bend 103 and a flattened part 101 to the flexible resilient portions, and may additionally form a contact 102 between the lip portions and the folded parts of the first plate.

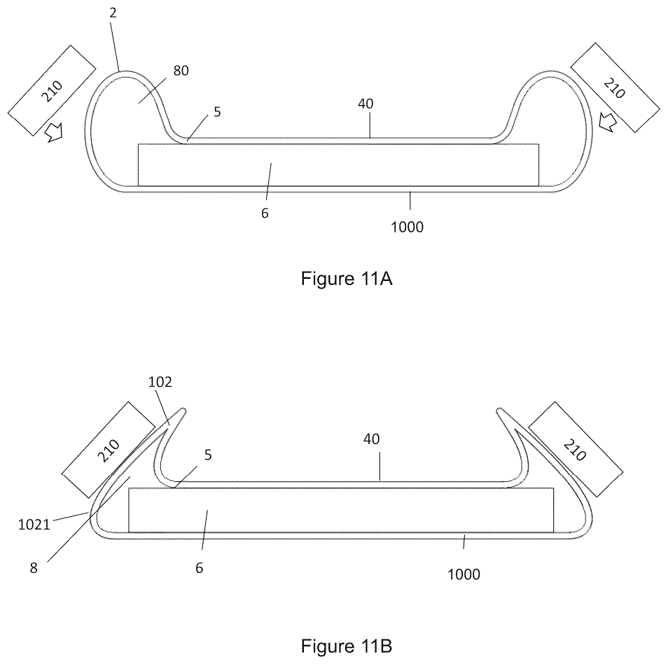

In some examples, the first planar portion, the second planar portion, the first flexible resilient portion, and the second flexible resilient portion may be formed from a single piece, or a tube (i.e. one or both of the planar portions may be continuous with one or both of the flexible resilient portions). As illustrated in FIG. 11A, a single piece may be deformed (e.g. around a power resistor assembly 6) to form a first planar portion 40 and a second planar portion 1000 on opposite sides of a power resistor assembly 6. First and second flexible resilient portions may be formed as bends between the first planar portion 40 and the second planar portion 1000. The formation of the planar portions and the flexible resilient portions may constitute a first deformation step. Prior to a second deformation step, the flexible resilient portions may define initial gaps 80. As illustrated in FIG. 11B, the flexible resilient portions may be deformed (e.g. by a tool 210) in a second deformation step to define the final gap 8. In the example illustrated in FIGS. 11A and 11B, the flexible resilient portions are continuous with the planar portions 40, 1000. Thus, the contact points 5 are defined as a point at which a flexible resilient member meets (is delineated from) the first planar portion 40. The folds or bends 1021, 102 introduced by the second deformation step are analogous to similar folds or bends illustrated in FIGS. 7B, 8B, 9B, and 10B.

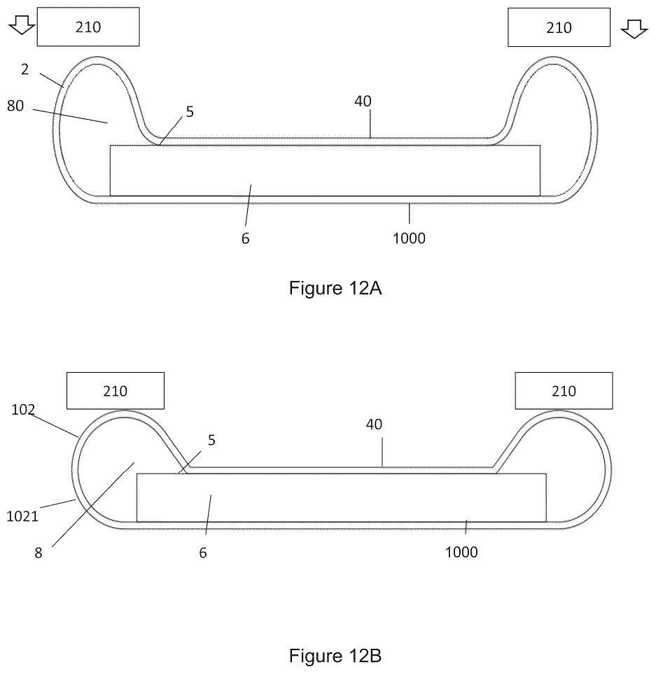

FIGS. 12A and 12B illustrate a similar example to that of FIGS. 11A and 11B, but with a vertical force applied in the second deformation step.

It will be appreciated that, in the examples illustrated above, the flexible resilient portions comprise substantially curved bends. That is, a first deformation step may comprise forming the substantially curved bends. A second deformation step may comprise applying a force to the bends to counteract a vertical displacement of one or both of the flexible resilient portions.

In some examples, a first deformation step may comprise forming the first flexible resilient portion, and a second deformation step may comprise forming the second flexible resilient portion.

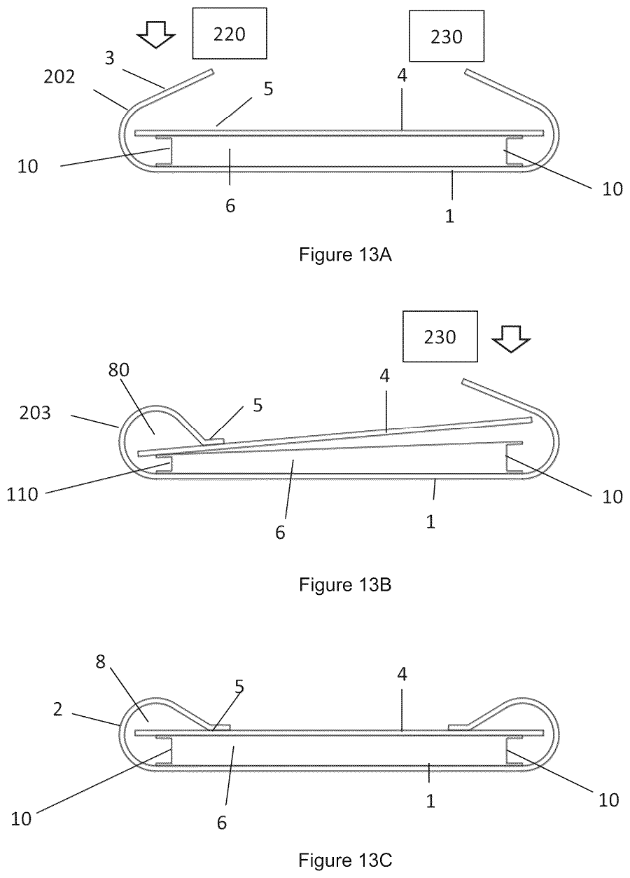

FIG. 13A illustrates a partly formed power resistor device according to the present disclosure. The power resistor device may be similar to the power resistor device illustrated in FIG. 2 and described above.

As illustrated in FIGS. 13A and 13B, a substantially curved bend may be introduced to a first lip portion 202 (e.g. using a tool 220) to form a first flexible resilient portion 203 that contacts the first planar portion (first plate 4) at a contact point 5. The formation of the first flexible resilient portion 203 may lead to a vertical displacement between the first planar portion and the power resistor assembly 6 (illustrated in FIG. 13B where the first plate 4 is angled upwards from the contact point 5 between the first flexible resilient portion and the first plate). This may also lead to vertical displacement between the edges 110, 10 of the power resistor assembly 6. In order to counteract the vertical displacement, the second flexible resilient portion is formed in a second deformation step, performed after the first deformation step (e.g. using a tool 230 as illustrated in FIG. 13B), to form the final power resistor device illustrated in FIG. 13C.

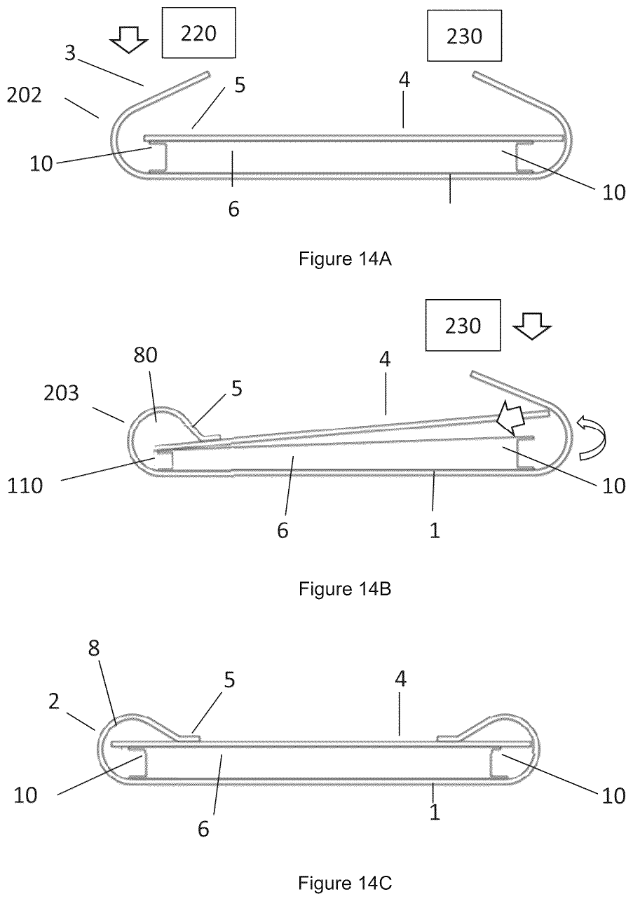

Advantageously, examples according to the present disclosure are particularly suited to a mass-production process. In particular, the devices and methods described herein may be very tolerant of the lateral positioning of the first planar portion, or first plate 4. As shown in FIGS. 14A-C, the first plate 4 may be initially situated off-centre relative to the power resistor assembly 6 (FIG. 14A). Following or during a first deformation step, in which the first flexible resilient portion 203, 2 is formed, the first plate 4 may be held in place by the first flexible resilient portion, and pivot upwards resulting in a vertical displacement as described above (FIG. 14B). A second deformation step, forming the second flexible resilient portion, may impart both vertical and lateral movement to the first plate 4 (see arrows in FIG. 14B), which may simultaneously counteract the vertical displacement of the first plate 4, and cause the first plate 4 to be displaced along the horizontal direction. The resulting device, shown in FIG. 14C, may then comprise a first plate 4 that is not arranged centrally with respect to the power resistor assembly 6. However, such a device would still exhibit the same performance improvements over prior art devices, as described herein with respect to other examples.

In view of the above, it will be appreciated that the first and second deformation steps can take different forms, but that it is preferable to form the bends of the first and second resilient portions in two deformation steps to prevent, or counteract, vertical displacement between the enclosure and the power resistor assembly, and/or between layers of the power resistor assembly.

In all of the examples described herein, it is preferable that the contact points 5 are spaced away from the edges 10 of the power resistor assembly 6 (towards the centre of the device) by at least a distance equal to a thickness of the power resistor assembly 6.

In some examples, enclosures according to the present disclosure may act as a distributed spring independently of the stiffness or elasticity or compliance of the internal structure (i.e. the power resistor assembly).

While FIG. 3 illustrates planar portions and flexible resilient portions along the full length of the power resistor device, in some examples it will be understood that the enclosure may comprise two or more enclosure pieces (not shown), with parts of the power resistor device exposed therebetween. For example, the enclosure may comprise two or more strips of planar portion material and flexible resilient portion material arranged along the length of the device, grouped into two or more enclosure pieces.

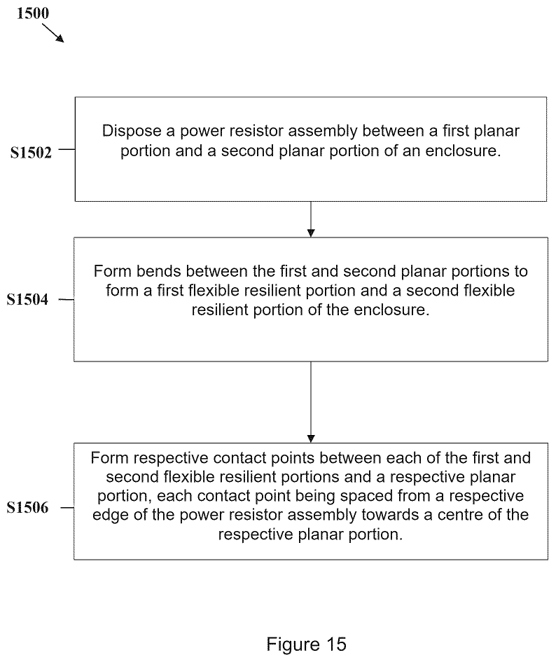

FIG. 15 illustrates a method 1500 for enclosing a power resistor assembly as described herein.

At step S1502 of the method 1500, a power resistor assembly is disposed between a first planar portion and a second planar portion of an enclosure. As described and illustrated herein, the first and second planar portion may be separate portions of material (e.g. plates), or they may be formed from a single piece (e.g. a tube).

At step S1504 of the method 1500, bends are formed between the first and second planar portions to form a first flexible resilient portion and a second flexible resilient portion of the enclosure. As described and illustrated herein, the flexible resilient portions may be formed as lips. In some examples, the flexible resilient portions are formed with the planar portions as a single piece (e.g. a tube).

At step S1506 of the method 1500, respective contact points are formed between each of the first and second flexible resilient portions and a respective planar portion, each contact point being spaced from a respective edge of the power resistor assembly towards a centre of the respective planar portion. As described and illustrated herein, the contact points are preferably formed such that each contact point is spaced from the respective edge of the power resistor assembly towards the centre of the respective planar portion by at least a distance equal to a thickness of the power resistor assembly.

Although the disclosure has been described in terms of the embodiments set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

1. A power resistor device comprising:
a power resistor assembly; and
an enclosure, the enclosure comprising:
a first planar portion;
a second planar portion;
a first flexible resilient portion; and
a second flexible resilient portion;
wherein the power resistor assembly is arranged between the first and second planar portions of the enclosure;
wherein the first flexible resilient portion and the second flexible resilient portion each form a bend between the first and second planar portions; and
wherein the first flexible resilient portion and the second flexible resilient portion each contact a planar portion at a respective contact point, each contact point being spaced from a respective edge of the power resistor assembly towards a centre of the respective planar portion.

2. A power resistor device according to claim 1, wherein each contact point is spaced from the respective edge of the power resistor assembly towards the centre of the respective planar portion by at least a distance equal to a thickness of the power resistor assembly.

3. A power resistor device according to claim 1, wherein the first and second flexible resilient portions each comprise at least one fold.

4. A power resistor device according to claim 1, wherein the first and second flexible resilient portions together exert a pressure on the power resistor assembly of at least 5 kg/cm².

5. A method for enclosing a power resistor assembly, the method comprising:
disposing a power resistor assembly between a first planar portion and a second planar portion of an enclosure;
forming bends between the first and second planar portions to form a first flexible resilient portion and a second flexible resilient portion of the enclosure; and
forming respective contact points between each of the first and second flexible resilient portions and a respective planar portion, each contact point being spaced from a respective edge of the power resistor assembly towards a centre of the respective planar portion.

6. A method according to claim 5, comprising forming the contact points such that each contact point is spaced from the respective edge of the power resistor assembly towards the centre of the respective planar portion by at least a distance equal to a thickness of the power resistor assembly.

7. A method according to claim 5, wherein forming the bends comprises a first deformation step and a second deformation step.

8. A method according to claim 7, wherein the first deformation step comprises forming a bend to form the first flexible resilient portion, and wherein the second deformation step comprises forming a bend to form the second flexible resilient portion.

9. A method according to claim 7, wherein the first deformation step comprises forming substantially curved bends, and wherein the second deformation step comprises applying a force to the bends to counteract a vertical displacement of one or both of the flexible resilient portions.

10-17. (canceled)

18. An enclosure for a power resistor assembly, the enclosure comprising:
a first plate and a second plate, the first and second plates each comprising a body portion, the body portions being arranged parallel to one another;
wherein at least one of the first plate and the second plate further comprises a lip portion, and wherein at least the other of the first plate and the second plate further comprises an edge;
wherein the lip portion of the at least one of the first plate and the second plate is folded around the other of the first and second plates; and
wherein the lip portion of the at least one of the first plate and the second plate contacts the body portion of the other of the first and second plates at a contact point, wherein the contact point is spaced from the edge of the other of the first and second plates.

19. An enclosure according to claim 18, wherein the lip portion is folded in a substantially arced shape.

20. An enclosure according to claim 18, further comprising a gap between the contact point and the edge.

21. An enclosure according to claim 18, wherein the first plate comprises at least two edges, and wherein the second plate further comprises at least two lip portions, each lip portion being folded around the first plate, and wherein each lip portion contacts the body portion of the first plate at a respective contact point spaced from a respective edge of the first plate.

22. An enclosure according to claim 18, wherein the first plate and the second plate each comprise a respective lip portion and edge;
wherein the lip portion of the first plate is folded around the second plate; and
wherein the lip portion of the second plate is folded around the first plate;
wherein the lip portions of the first and second plates contact the body portions of the respective other of the first and second plates such that the contact points spaced from the respective edges of the other of the first and second plates.

23. An enclosure according to claim 18, the enclosure being configured such that a substantially uniform pressure is applied across an area of a power resistor assembly disposed between the first plate and the second plate.

24. An enclosure according to claim 18, wherein each contact point is positioned substantially at a midpoint between the respective edge of the contacted plate and a centre of said contacted plate, and/or at a midpoint between a respective assembly edge and a centre of the contacted plate.

25-27. (canceled)
